(19) United States
(12) Patent Application Publication
(10) Pub. No.: US 2006/0125572 A1
(43) Pub. Date: Jun. 15, 2006

(54) Balanced nonlinear transmission line phase shifter

(76) Inventors: Daniel W. van der Weide, Madison, WI (US); Hong-Joon Kim, Madison, WI (US)

Correspondence Address: FOLEY & LARDNER LLP, 150 EAST GILMAN STREET, P.O. BOX 1497, MADISON, WI, 53701-1497, US

(21) Appl. No.: 11/008,694

(22) Filed: Dec. 9, 2004

(51) Int. Cl. H04B 3/04

(52) U.S. Cl. 333/20

(57) ABSTRACT

A nonlinear transmission line phase shifter has multiple transmission line sections connected together at nodes in series between input and output terminals. First and second diodes are connected to each node in parallel with each other and with opposite polarity. A bias voltage source is connected to the first diodes to bias the diodes off and a bias voltage source is connected to the second diodes to bias the second diodes off. During operation, one of the two diodes in each section slows the phase velocity while the other accelerates the phase velocity, so that harmonic distortion can be reduced as compared to conventional nonlinear transmission line structures.

### REFERENCE TO GOVERNMENT RIGHTS

This invention was made with United States government support awarded by the following agencies: USAF/AFOSR F49620-02-1-0329. The United States government has certain rights in this invention.

### FIELD OF THE INVENTION

The present invention pertains generally to the field of non-linear transmission lines and phase shifters.

### BACKGROUND OF THE INVENTION

Nonlinear transmission line structures have been used for various purposes. These applications include shock wave generators, e.g., as discussed in D. W. van der Weide, “Delta-Doped Schottky Diode Nonlinear Transmission Lines for 480-fs, 3.5 V Transients,” Applied Physics Letters, Vol. 65, 1994, pp. 881-883. Other applications include sampling circuit drivers and harmonic generators. See, e.g., M. J. W. Rodwell, et al., “GaAs Nonlinear Transmission Lines for Picosecond Pulse Generation and Millimeter-Wave Sampling,” IEEE Trans. Microwave Theory Tech., Vol. 39, No. 7, July, 1991, pp. 1194-1204. Nonlinear transmission lines have also been used for variable time delay lines, and are particularly attractive for use in the linear (or small signal) mode as phase shifting circuits because of compatibility with nonlinear transmission line pulse generator fabrication processes. A. S. Nagra and R. A. York, “Monolithic GaAs Phase Shifter with Low Insertion Loss and Continuous 0°-360° phase shift at 20 GHz,” IEEE Microwave Guided Wave Lett., Vol. 9, January 1999, pp. 31-33; W. M. Zhang, et al., “Novel Low Loss Delay Line for Broadband Phase Antenna Array Applications,” IEEE Microwave Guided Wave Lett., Vol. 7, November 1996, pp. 395-397; R. P. Hsia, et al., “A Hybrid Nonlinear Delay Line-Based Broad-Band Based Antenna Array,” IEEE Microwave Guided Wave Lett., Vol. 8, May, 1996, pp. 182-184; P. Akkaraekthalin, et al., “Distributed Broadband Frequency Translator and its Use in a 1-3 GHz Coherent Reflectometer,” IEEE Transactions on Microwave Theory and Techniques, Vol. 46, 1998, pp. 2244-2250.

A typical conventional nonlinear transmission line (NLTL) structure utilizes varactor diodes which are usually distributed on a high-impedance transmission line, with the nonlinearity arising from the diode capacitance which varies with the voltage across it. Thus, the conventional (large signal) NLTL locally self-modulates its delay with the waveform propagating along it. The same NLTL structure can also be used in a small signal mode in which a DC bias on the line controls the time delay of the NLTL structure.

A circuit schematic for the conventional NLTL structure is shown in FIG. 1. A high frequency AC source 10 is connected to input terminals 11 (which may be simply connecting lines, etc.) of the NLTL. The NLTL structure of FIG. 1 has several transmission line sections 13 connected in series at nodes 15. The transmission line sections 13 are formed in a conventional fashion for NLTLs, and may be continuous conductors providing distributed series inductance and parallel capacitance or lumped elements. Varactor diodes 17 are connected between the connecting lines or nodes 15 and ground, with one of the input terminals 11 also connected to ground (which effectively acts as a return conducting line between one of the input terminals and one of the output terminals). Although two diodes 17 are shown connected to each connecting line node 15, a single diode may be connected between the node and ground, or more than two diodes may be connected in parallel between the nodes 15 and ground. A DC voltage source 20 is connected in series with the sections 13 and provides a DC bias voltage to the string of transmission line sections and the nodes 15 that normally biases the diodes 17 off. In the case shown in FIG. 1, the diodes 17 are oriented to conduct current away from the nodes 15 and to block current flow toward the nodes 15, and the voltage source 20 is connected in the line with a polarity to provide a reverse bias voltage across each diode 17 so that it is normally non-conducting. The effective capacitance across the diodes 17 will vary with the AC voltage applied to the diodes from the voltage source 10. The output signal from the NLTL structure of FIG. 1 is provided at output terminals 22, with one of the terminals connected to the last connecting line node 15 in the series and the other output terminal 22 connected to ground. Again, these output terminals may simply be conducting lines or connectors.

Because the NLTL of FIG. 1 is a low-pass filter structure, it has a periodic cut-off frequency (Bragg frequency) given by

$${f}_{Bragg} = \frac{1}{π \cdot \sqrt{{L}_{l} [ {C}_{l} + {C}_{d} ( V ) ]}}$$

where Lₗ and Cₗ are transmission line section inductance and capacitance, respectively, and C_{d}(V) is voltage variable diode capacitance. In the basic NLTL structure, diodes are periodically placed on a coplanar waveguide (CPW) with a spacing “d” between them. When the signal propagates on this NLTL, the phase velocity of a wave on the NLTL is a function of voltage and is given by

$${μ}_{p} = \frac{d}{\sqrt{{L}_{l} [ {C}_{l} + {C}_{d} ( V ) ]}} .$$

The diode capacitance value decreases with an increase in reverse bias. Thus, at the peak of the sinusoid where diode capacitance is largest, the signal propagates slower, while at the trough where diode capacitance is smallest, it propagates faster, generating a shock wave and harmonics. See P. Akkaraekthain, supra. In a single-ended NLTL phase shifter, the cathodes of the diodes 17 are grounded, as shown in FIG. 1. In the conventional NLTL structure of FIG. 1, both of the diodes 17 connected to each node 15 slow the phase velocity at the peak and accelerate it at the trough of the sinusoid.

### SUMMARY OF THE INVENTION

A balanced nonlinear transmission line phase shifter in accordance with the invention provides significantly reduced harmonic distortion at the output as compared to conventional nonlinear transmission line structures. The balanced nonlinear transmission line phase shifter of the invention minimizes nonlinearities inherent in the nonlinear transmission line structure without requiring additional devices or more complex control. The invention is well suited to be implemented in a compact package including implementation as an integrated circuit.

The phase shifter of the invention includes input and output terminals and multiple transmission line sections connected together at nodes in series in between the input and output terminals. First and second diodes are connected to each transmission line section in parallel with each other and with opposite polarity. A bias voltage source is connected to the first diodes to bias the first diodes off and a bias voltage source is connected to the second diodes to bias the second diodes off. Because the diodes are connected in parallel with opposite polarity, as the sinusoidal voltage propagates down the transmission line, one of the first or second diodes slows the phase velocity while the other of the diodes accelerates the phase velocity, while the overall line capacitance changes in the same way as for a conventional structure. This allows the harmonic distortion to be much smaller in the balanced nonlinear transmission line structure of the invention as compared to conventional nonlinear transmission lines.

The nonlinear transmission line phase shifter of the invention can be formed of conventional components such as varactor diodes which may be mounted on an insulating base and connected together by connectors formed on the base. The bias voltage sources for the first and second diode may be implemented in various ways, including a single voltage source connected in series with all of the first diodes and a single voltage source connected in series with all of the second diodes, and a single voltage source connected in series with the transmission line sections to apply a bias voltage to all of the first diodes and a single voltage source connected in series with all of the second diodes to bias the second diodes off.

Further objects, features and advantages of the invention will be apparent from the following description when taken in conjunction with the accompanying drawings.

### BRIEF DESCRIPTION OF THE DRAWINGS

In the drawings:

FIG. 1 is a schematic circuit diagram of a conventional nonlinear transmission line based phase shifter.

FIG. 2 is a schematic circuit diagram of a balanced NLTL phase shifter in accordance with the invention.

FIG. 3 is a schematic circuit diagram of a further implementation of the balanced NLTL phase shifter of the invention.

FIG. 4 are graphs showing insertion loss as a function of frequency at 0 V and −5 V DC bias for a conventional NLTL and for the balanced NLTL of the invention.

FIG. 5 are graphs showing phase variation as a function of bias voltage for the conventional NLTL and the balanced NLTL of the invention at 500 MHz.

FIG. 6 are graphs comparing harmonic distortion for the conventional NLTL and the balanced NLTL of the invention with input power at 4 dBm (500 MHz) with 0 V DC bias.

FIG. 7 are graphs as in FIG. 6 with a DC bias of −1 V.

FIG. 8 are graphs of output spectrum for the conventional NLTL and the balanced NLTL of the invention when higher power (+10 dBm at 500 MHz) is applied at a bias of −1 V.

### DETAILED DESCRIPTION OF THE INVENTION

An exemplary embodiment of an NLTL phase shifter in accordance with the invention is shown generally at 30 in FIG. 2. The phase shifter 30 receives an AC input signal from a high frequency signal source 10 (e.g., a radio frequency signal generator) at input terminals 31 (which may be simply connecting lines and/or leads, etc.). The NLTL structure of the phase shifter 30 includes a plurality of series connected transmission line sections 32 which are electrically connected to one of the input terminals 31 at one end of the series and to an output terminal 34 at the other end of the series string, with the other output terminal 34 connected to ground. The transmission line sections 32 may be formed in a conventional fashion for nonlinear transmission lines, with a node 35 at an end of each section at which the sections are connected together. A node 35 at the end of the transmission line is connected to an output terminal 34. For example, the transmission line sections 32 may be formed as sections of a distributed element transmission line, with distributed series inductance and parallel capacitance, or as a lumped element line formed of several discrete series inductors and discrete parallel capacitors. The distributed transmission line sections 32 may be continuous with one another, in which case the nodes 35 are positions at which connections are made to the line. A load 36 may be connected to the output terminals 34. A first diode 37 is connected from each of the nodes 35 to ground (and is thus electrically connected to one of the input terminals 31 and one of the output terminals 34). For the structure shown in FIG. 2, the first diodes 37 are poled or oriented to conduct current away from the nodes 35 to ground and to block current in the opposite direction. A DC bias voltage source 39 for the first diodes is connected in series between one of the input terminals 31 and the series connected string of transmission line sections 32 to provide a DC bias to the transmission line sections and to the nodes 35 between them. The voltage source 39 provides a DC bias across each of the first diodes 37 to reverse bias the diodes off. Second diodes 41 are connected from each of the nodes 35 to a return conductor 42 which is connected to ground. The second diodes 41 are poled or oriented to conduct current toward the nodes 35 and to block current flow in the opposite direction. The diodes 37 and 41 at each node are effectively connected to a transmission line section in parallel with each other and with opposite polarity. A bias voltage source 44 for the second diodes (which may comprise two voltage sources connected in series) is connected in the conducting line 42 between ground and the diodes 41, in series with all of the diodes 41, to apply a bias voltage to the diodes 41 to reverse bias the diodes off. Because the voltage source 39 connected to the string of transmission line sections 32 would provide a bias voltage of value “V” across the diodes 41 in a forward direction, the voltage source 44 applies a voltage greater than “V,” e.g., 2V, to thereby bias the diodes 41 off. Although the effective bias voltages applied to the first diodes 37 and to the second diodes 41 need not be equal, it is generally preferred for balanced operation that the effective bias voltages across the diodes 37 and 41 are the same.

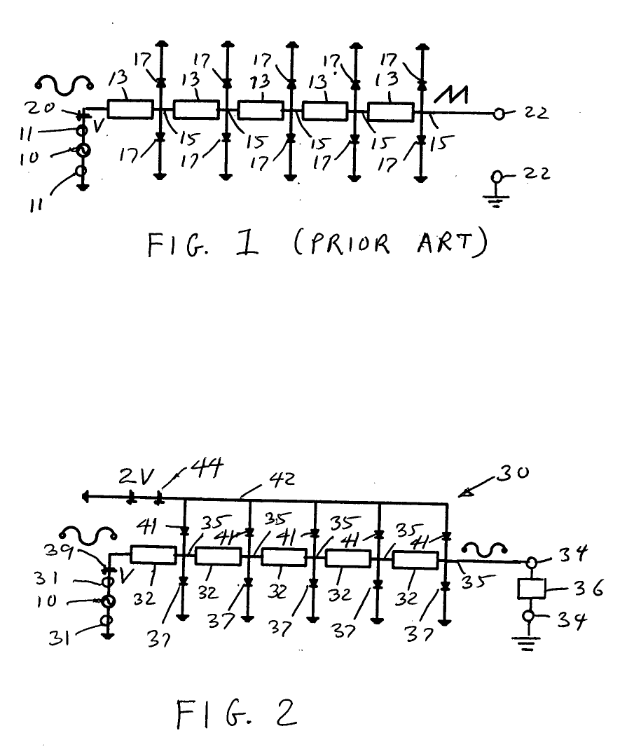

As noted above, in the conventional NLTL structure of FIG. 1, both of the diodes 17 at each node 15 locally slow the phase velocity at the peak and accelerate it at the trough of the sinusoid propagating down the transmission line from the signal source 10, through self-phase modulation. In the balanced NLTL phase shifter structure 30 of the invention, one of the diodes 37 or 41 locally slows the phase velocity while the other of the diodes locally accelerates the phase velocity, although the overall line capacitance changes in the same way as for the conventional NLTL structure. Thus, harmonic distortion at the output can be much smaller in the balanced structure of the invention as compared to the conventional NLTL structure.

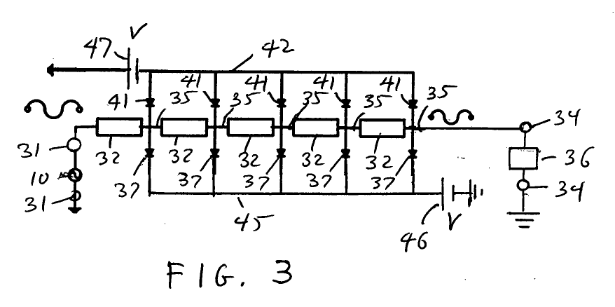

FIG. 3 shows another embodiment of the NLTL phase shifter of the invention with a rearranged bias circuit for the diodes 37 and 41. In the structure of FIG. 3 a single bias voltage source 46 is connected in series via a line 45 to each of the diodes 37 and a single bias voltage source 47 is connected in series via a line 42 to each of the diodes 41. The bias voltage sources 46 and 47 are connected to a ground which is connected between an input terminal 31 and an output terminal 34. Conventional ground return structures may be utilized, such as a metal ground plane conductor. In the phase shifter of FIG. 3, the bias voltage sources 46 and 47 preferably have the same voltage level V, but are oriented to reverse bias the diodes to which they are connected. Other suitable bias arrangements may be used including a separate bias voltage supply for each diode, etc.

The following example describes the construction and performance of a balanced NLTL phase shifter structure of the type shown in FIG. 2 as compared with the conventional structure of FIG. 1.

Hybrid phase shifters as shown schematically in FIGS. 1 and 2 were fabricated on Rogers RT/Druid 3010 (εᵣ=10.2) by attaching Alpha Industries hyper-abrupt junction GaAs flip-chip varactor diodes (GMV-9821 (Cj0=1.07 pF, Cmax/Cmin≈3.6 for 0-5V reverse bias)) to the CPW using conductive silver epoxy. The design was an inductive line (Z₀=75 Ω) setting Z₀(V)=50 Ω when the diode capacitance is maximum, because, at that point, the insertion loss is maximum and thus it was desired to minimize reflection loss. Ten transmission line sections and 20 diodes were used for the two structures implementing the conventional NLTL of FIG. 1 and the balanced NLTL of FIG. 2.

S-parameters were measured using an Agilent E8364A network analyzer. According to theory, the Bragg frequency should be approximately 1.6 GHz but in reality, the −10 dB point is at 1.4 GHz at 0 V bias (see FIG. 4) for both structures. This difference is believed to be due to parasitics associated with attaching the diodes on the coplanar waveguide (CPW) line with silver epoxy. Because the two structures have the same dimensions and number of diodes, they behave almost identically. To see how the balanced structure reduces harmonics, let the operating frequency be much lower than the Bragg frequency. In this experiment, 500 MHz was used, a frequency where both structures have very similar phase variation with voltage (see FIG. 5).

To compare harmonic components, an Agilent E4448 spectrum analyzer was used. Since the balanced structure of FIG. 2 requires an additional voltage doubled bias line, the following discussion of the balanced NLTL will assume that a doubled voltage was applied to the additional bias line (line 42 in FIG. 2). For example, if it is stated that the experiments were conducted with a −1 V DC bias, it should be assumed that a −1 V bias for the first diodes and an additional −2 V DC bias for the second diodes were applied to the balanced structure of FIG. 2.

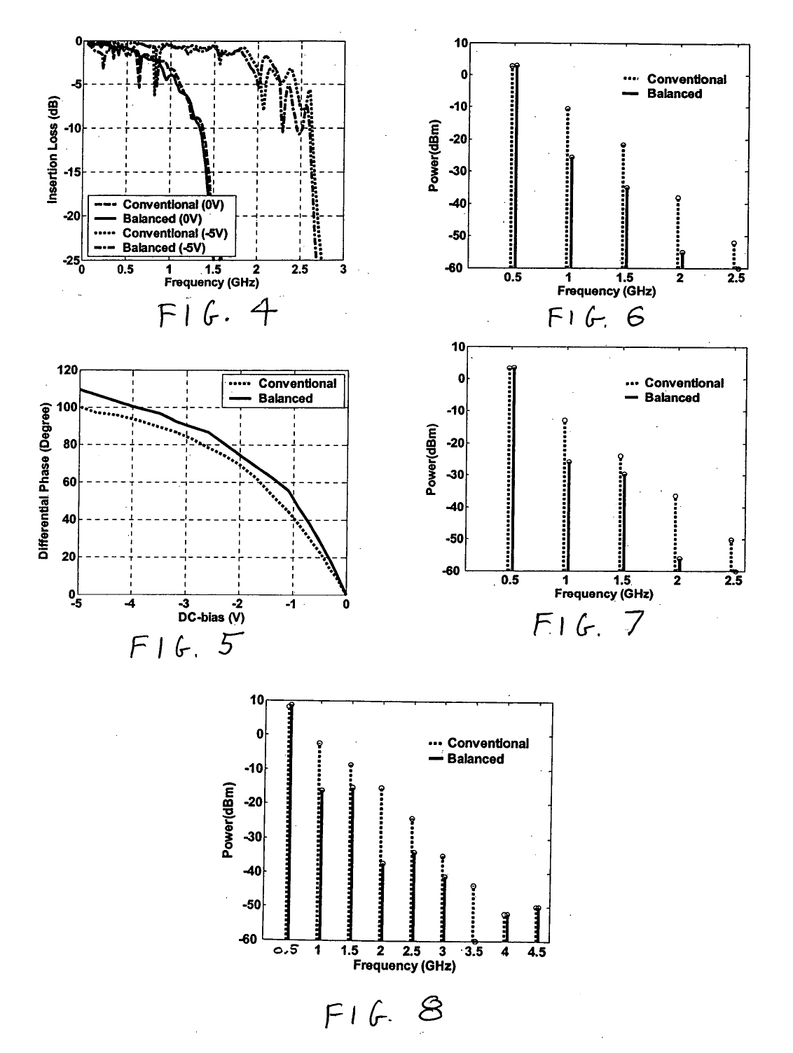

With a +4 dBm sinusoid input at 500 MHz, harmonics were measured at 0 V and −1 V. FIGS. 6 and 7 show harmonic components of both structures when the DC bias is 0 V and −1 V, respectively. Harmonics below −60 dBm were below the noise floor. All of the harmonics of the balanced structure are at least 13 dB lower than corresponding harmonics of the conventional structure at 0 V. At −1 V, it can be seen that harmonics are also less severe in the balanced structure. As DC bias voltage is increased, the capacitance variation with applied signal voltage becomes less severe, and the differences in the harmonics between the two structures is gradually reduced.

These harmonic effects are much more pronounced if input power is increased, as shown in FIG. 8. Also, for the structures discussed here, phase variation is around 1000 at 500 MHz, and if more sections are added to increase the phase variation, harmonic generation will increase as well. For such cases, the balanced structure of the invention is a better solution than the conventional NLTL to minimize nonlinearities.

Thus, the balanced NLTL structure of the invention minimizes nonlinearities inherent in the NLTL structure without additional devices or more complex control. Although the exemplary circuit discussed above was implemented in a hybrid structure, the implementation of the invention in an integrated circuit is preferable so as to minimize parasitics.

The present invention may also be utilized in phased antenna arrays (PAA) for radar and smart antenna systems having relatively high input power levels. For such systems, the balanced structure of the present invention is particularly advantageous because of minimized harmonic distortion. The phase shifter of the invention may further advantageously be used in measurement systems, such as relectometers (based on frequency translation), since the reduced harmonic distortion allows more accurate measurements.

It is understood that the invention is not confined to the particular embodiments set forth herein as illustrative, but embraces all such forms thereof as come within the scope of the following claims.

What is claimed is:

1. A nonlinear transmission line system comprising:
(a) input and output terminals;
(b) multiple transmission line sections connected together at nodes in series between the input and output terminals;
(c) first and second diodes at each node connected to each transmission line section and to ground in parallel with each other and with opposite polarity; and
(d) a bias voltage source connected to the first diodes to bias the first diodes off and a bias voltage source connected to the second diodes to bias the second diodes off.

2. The system of claim 1 wherein the diodes are varactor diodes.

3. The system of claim 2 wherein the varactor diodes are mounted on an insulating base and are connected together by metalized connector strips formed on the base and extending to contacts on the diodes, and wherein the inductances are formed of metal connector strips.

4. The system of claim 3 wherein the insulating base is formed of glass or alumina and including a ground plane conductor formed of a sheet of metal.

5. The system of claim 1 further including a high frequency source coupled to the input terminals and including a load coupled to the output terminals.

6. The system of claim 1 wherein the bias voltage sources provide equal voltages of opposite polarity across the first and second diodes.

7. The system of claim 1 wherein the bias voltage source for the first diodes comprises a single voltage source connected in series with all of the first diodes and the bias voltage source for the second diodes comprises a single voltage source connected in series with all of the second diodes.

8. The system of claim 1 wherein the bias voltage source for the first diodes comprises a single voltage source connected in series to the transmission line sections to provide a bias voltage across all of the first diodes, and wherein the bias voltage source for the second diodes comprises a voltage source connected in series with all of the second diodes.

9. The system of claim 8 wherein the first diode voltage source provides a voltage at a level V and the second diode voltage source provides a voltage at a level 2V.

10. A method of providing a phase shifted high frequency output signal comprising:
(a) providing a nonlinear transmission line system comprising:
(1) input and output terminals;
(2) multiple transmission line sections connected together at nodes in series between the input and output terminals; and
(3) first and second diodes at each node connected to each transmission line section and to ground in parallel with each other and with opposite polarity;
(b) applying a bias voltage to the first diodes to bias the first diodes off;
(c) applying a bias voltage to the second diodes to bias the second diodes off;
(d) supplying a high frequency signal to the input terminals that propagates down the sections of the transmission line to the output terminals; and
(e) supplying the signal at the output terminals to a load.

11. The method of claim 10 wherein the bias voltages are applied to the first and second diodes at equal voltages of opposite polarity.
